(19) United States
(12) Patent Application Publication
(10) Pub. No.: US 2025/0294358 A1
(43) Pub. Date: Sep. 18, 2025

(54) METHODS, SYSTEMS, AND COMPUTER READABLE MEDIA FOR FILTERING INTER-PUBLIC LAND MOBILE NETWORK (PLMN) MESSAGES AT SECURITY EDGE PROTECTION PROXY (SEPP) TO IMPLEMENT ROAMING AGREEMENTS

(71) Applicant: Oracle International Corporation, Redwood Shores, CA (US)

(72) Inventors: John Nirmal Mohan Raj, Bangalore (IN); Sonia Kadyan, New Delhi (IN); Ashish Jyoti Sharma, New Delhi (IN); Jay Rajput, Bangalore (IN)

(21) Appl. No.: 18/608,071

(22) Filed: Mar. 18, 2024

(51) Int. Cl. H04W 12/088

(52) U.S. Cl. CPC H04W 12/088

(57) ABSTRACT

A method for screening inter-PLMN messages at a SEPP to implement roaming agreements includes storing an originating and target network mapping database containing records including mappings between originating network identifiers and target network identifiers. The method further includes receiving, at the SEPP, an inter-PLMN SBI request message originating from an NF in a network served by the SEPP. The method further includes determining originating and target network identifiers from the message, locating a matching record in the database, and determining, from the record, whether the message should be allowed to flow from the originating network to the target network. The method further includes forwarding the message to the target network or preventing the forwarding of the message to the target network based on results of the determining.

### TECHNICAL FIELD

The subject matter described herein relates to filtering inter-PLMN messages. More particularly, the subject matter described herein relates to methods, systems, and computer readable media for filtering inter-PLMN messages at a SEPP based on combinations of source and destination PLMN ID to implement roaming agreements between mobile network operators (MNOs) and mobile virtual network operators (MVNOs).

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF instance is an instance of a producer NF that provides a service. A given producer NF may include more than one NF instance. It should also be noted that multiple NF instances can share the same service endpoint.

NFs register with a network function repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

An SCP can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem that can occur in 5G and subsequent generation networks relates to offering seamless roaming service to users according to roaming agreements among MNOs and/or MVNOs. Messages originating from a serving PLMN to a home PLMN must be filtered to implement roaming agreements. Using current configurations, a SEPP may be incapable of performing the fine-grained filtering required to implement complex roaming agreements where messages from the serving PLMN are allowed to flow to some PLMNs but not to other PLMNs. In addition, some messages may lack serving PLMN identification information, further increasing the difficulty in performing source-and destination-based inter-PLMN filtering.

Accordingly, in light of these and other difficulties, there exists a need for improved methods, systems, and computer readable media for filtering inter-PLMN messages at a SEPP to implement roaming agreements.

### SUMMARY

A method for screening inter-public land mobile network (PLMN) messages at a security edge protection proxy (SEPP) to implement roaming agreements includes storing, in memory accessible by the SEPP, an originating and target network mapping database containing records including mappings between originating network identifiers and target network identifiers. The method further includes receiving, by the SEPP, an inter-PLMN SBI request message originating from a network function (NF) in a network served by the SEPP. The method further includes determining, by the SEPP and from the inter-PLMN SBI request message, an originating network identifier. The method further includes determining, by the SEPP and from the inter-PLMN SBI request message, a target network identifier. The method further includes accessing, by the SEPP and using the originating and target network identifiers determined from the message, the originating and target network mapping database. The method further includes locating, by the SEPP and in the originating and target network mapping database, a record corresponding to the originating network identifier and/or the target network identifier. The method further includes determining, by the SEPP and from the record, whether the message should be allowed to flow from an originating network corresponding to the originating network identifier to a target network corresponding to the target network identifier. The method further includes, when the SEPP determines that the message should be allowed to flow from the originating network to the target network, forwarding the message to the target network. The method further includes, when the SEPP determines that the message should not be allowed to flow from the originating network to the target network, preventing forwarding of the message to the target network.

According to another aspect of the subject matter described herein, the records include mappings between allowed or blocked originating network identifiers for target networks indicated by the target network identifiers.

According to another aspect of the subject matter described herein, the records include mappings between allowed or blocked target network identifiers for originating networks indicated by the originating network identifiers.

According to another aspect of the subject matter described herein, originating and target network identifiers in the records include PLMN identifiers or SEPP identifiers.

According to another aspect of the subject matter described herein, determining the originating network identifier from the message includes reading the originating network identifier from a 3gpp-Sbi-Originating-Network-Id header of the message.

According to another aspect of the subject matter described herein, determining the target network identifier from the message includes determining the target network identifier from a 3gpp-Sbi-Target-apiRoot header of the message.

According to another aspect of the subject matter described herein, determining the originating network identifier from the message includes performing a domain name system (DNS) lookup using a fully qualified domain name (FQDN) constructed from the message and treating the FQDN as the originating network identifier when the DNS lookup returns a success response.

According to another aspect of the subject matter described herein, determining the originating network identifier from the message includes reading a dynamically assigned message identifier from the message and using the dynamically assigned message identifier to determine the originating network identifier.

According to another aspect of the subject matter described herein, determining whether the message should be allowed to flow from the originating network to the target network includes determining whether the originating network identifier determined from the message matches an originating network identifier in the record and determining whether the target network identifier determined from the message matches a target network identifier in the record.

According to another aspect of the subject matter described herein, the SEPP operates as one of: a hosted SEPP, a non-hosted SEPP, a roaming hub, a producer SEPP (P-SEPP) and a consumer SEPP (C-SEPP).

According to another aspect of the subject matter described herein, a system for screening inter-public land mobile network (PLMN) messages at a security edge protection proxy (SEPP) to implement roaming agreements is provided. The system includes a SEPP including at least one processor and a memory. The system further includes an originating and target network mapping database stored in the memory and containing a record storing mappings between originating network identifiers and target network identifiers. The system further includes an originating and target network mapper/validator implemented by the at least one processor for receiving an inter-PLMN SBI request message originating from a network function (NF) in a network served by the SEPP, determining, from the inter-PLMN SBI request message, an originating network identifier, determining, from the inter-PLMN SBI request message, a target network identifier, accessing, using the originating and target network identifiers determined from the message, the originating and target network mapping database, locating, in the originating and target network mapping database, a record corresponding to the originating network identifier and/or the target network identifier, determining, from the record, whether the message should be allowed to flow from an originating network corresponding to the originating network identifier to a target network corresponding to the target network identifier, when the originating and target network mapper/validator determines that the message should be allowed to flow from the originating network to the target network, forwarding the message to the target network, and when the originating and target network mapper/validator determines that the message should not be allowed to flow from the originating network to the target network, preventing forwarding of the message to the target network.

According to another aspect of the subject matter described herein, the records include mappings between allowed or blocked originating network identifiers for networks indicated by the target network identifiers.

According to another aspect of the subject matter described herein, the originating and target network identifier validator/mapper is configured to read the target network identifier from a 3gpp-Sbi-Target-apiRoot header of the message.

According to another aspect of the subject matter described herein, the originating and target network identifier validator/mapper is configured to determine the originating network identifier from the message by performing a domain name system (DNS) lookup using a fully qualified domain name (FQDN) constructed from the message and treating the FQDN as the originating network identifier when the DNS lookup returns a success response.

According to another aspect of the subject matter described herein, the originating and target network identifier validator/mapper is configured to determine the originating network identifier from the message by reading a dynamically assigned message identifier from the message and using the dynamically assigned message identifier to determine the originating network identifier.

According to another aspect of the subject matter described herein, the originating and target network identifier validator/mapper is configured to determine whether the message should be allowed to flow from the originating network to the target network by determining whether the originating network identifier determined from the message matches an originating network identifier in the record and determining whether the target network identifier determined from the message matches a target network identifier in the record.

According to another aspect of the subject matter described herein, a non-transitory computer readable medium having stored thereon executable instructions that when executed by a processor of a computer control the computer to perform steps is provided. The steps include storing, in memory accessible by security edge protection proxy (SEPP), an originating and target network mapping database containing records including mappings between originating network identifiers and target network identifiers. The steps further include receiving, by the SEPP, an inter-PLMN SBI request message originating from a network function (NF) in a network served by the SEPP. The steps further include determining, by the SEPP and from the inter-PLMN SBI request message, an originating network identifier. The steps further include determining, by the SEPP and from the inter-PLMN SBI request message, a target network identifier. The steps further include accessing, by the SEPP and using the originating and target network identifiers determined from the message, the originating and target network mapping database; locating, by the SEPP and in the originating and target network mapping database, a record corresponding to the originating network identifier and/or the target network identifier. The steps further include determining, by the SEPP and from the record, whether the message should be allowed to flow from an originating network corresponding to the originating network identifier to a target network corresponding to the target network identifier. The steps further include, when the SEPP determines that the message should be allowed to flow from the originating network to the target network, forwarding the message to the target network. The steps further include, when the SEPP determines that the message should not be allowed to flow from the originating network to the target network, preventing forwarding of the message to the target network.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a network diagram illustrating a SEPP that forwards messages between PLMNs and is unable to enforce roaming agreements;

FIG. 3 is a network diagram illustrating a SEPP that forwards messages between PLMNs and performs originating and target network validation to enforce roaming agreements;

FIG. 4 is a block diagram illustrating an exemplary architecture of a SEPP that forwards messages between PLMNs and performs originating and target network validation to enforce roaming agreements; and

FIG. 5 is a flow chart illustrating an exemplary process performed by a SEPP for forwarding messages between PLMNs and performing originating and target network validation to enforce roaming agreements.

### DETAILED DESCRIPTION

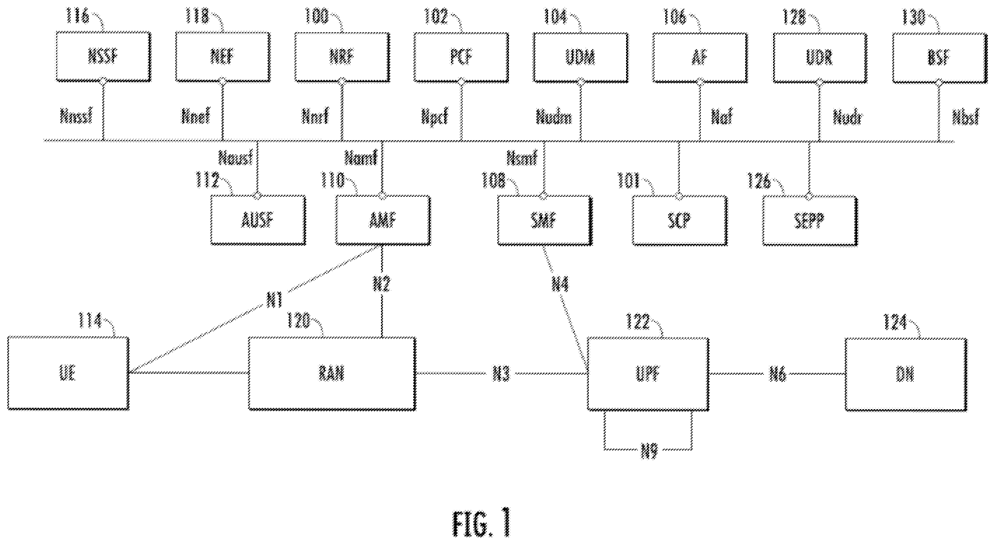

FIG. 1 is a block diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A SEPP 126 filters incoming traffic from another PLMN and can perform topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A SEPP filtering egress messages from consumer NFs in a PLMN is referred to a consumer SEPP or C-SEPP. A SEPP that filters ingress messages directed to consumer NFs in a PLMN is referred to as a producer SEPP or P-SEPP. A given SEPP can function as a C-SEPP and a P-SEPP, depending on the role the SEPP is performing.

A unified data repository (UDR) 128 stores subscription data for UEs. A binding support function (BSF) 130 manages bindings between PDU sessions and PCFs.

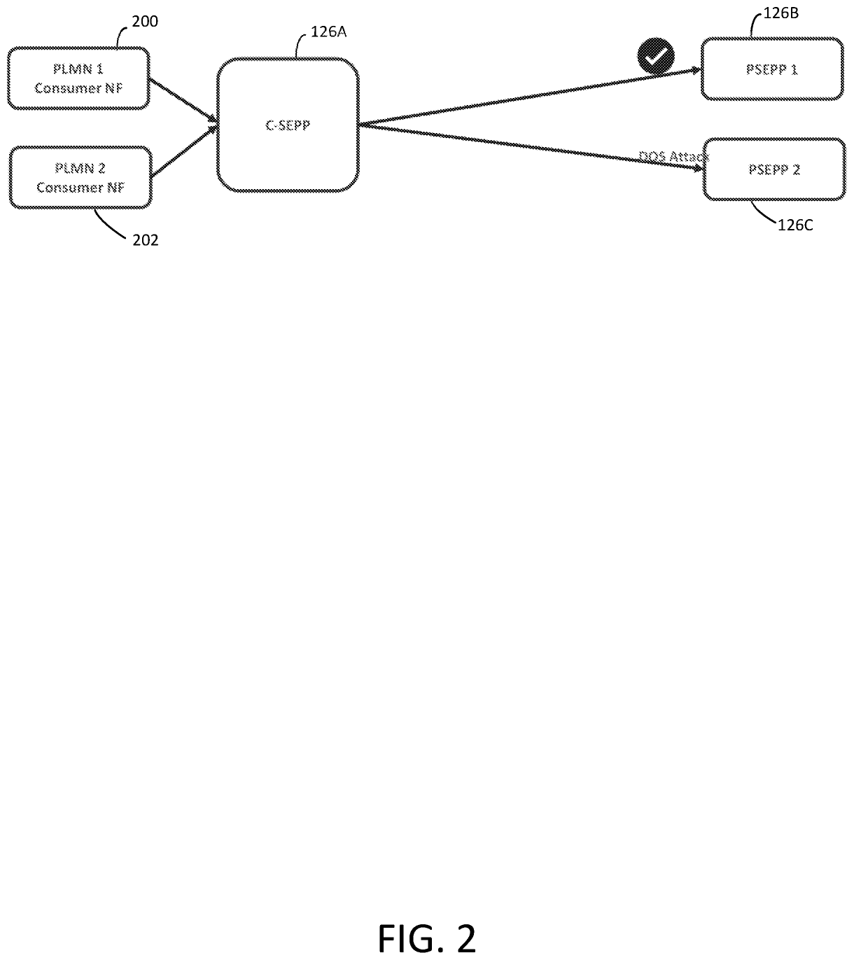

As described above, one problem that can occur in 5G and subsequent generation networks is that a SEPP may not be capable of filtering inter-PLMN messages to implement roaming agreements. FIG. 2 is a network diagram illustrating a SEPP that forwards messages between PLMNs and is unable to enforce roaming agreements. Referring to FIG. 2, a SEPP 126A functions as a C-SEPP to forward inter-PLMN SBI request messages from consumer NFs 200 and 202, which are in different PLMNs, to P-SEPPs 126B and 126C, which also serve different PLMNs. For purposes of explanation, it is assumed consumer NF 200 resides in PLMN 1, consumer NF 202 resides in PLMN 2, P-SEPP 126B protects PLMN 3, and P-SEPP 126C protects PLMN 4. C-SEPP 126A has N32 connections with P-SEPPs 126B and 126C and forwards messages from consumer NF 200 in PLMN 1 and consumer NF 202 in PLMN 2 to both of P-SEPP 126B in PLMN 3 and P-SEPP 126C in PLMN 4.

If the network operator of PLMN 1 has entered into a roaming agreement with the network operator of PLMN 3 but not PLMN 4, SEPP 126A should enforce this agreement by forwarding messages from consumer NF 200 in PLMN 1 to P-SEPP 126B and preventing the forwarding of messages from consumer NF 200 in PLMN 1 to P-SEPP 126C. However, because SEPP 126A has N32-C connections with both of P-SEPPs 126B and 126C, SEPP 126A does not have a mechanism for selectively forwarding messages from PLMN 1 to PLMN 3 but not PLMN 4 to enforce the roaming agreement.

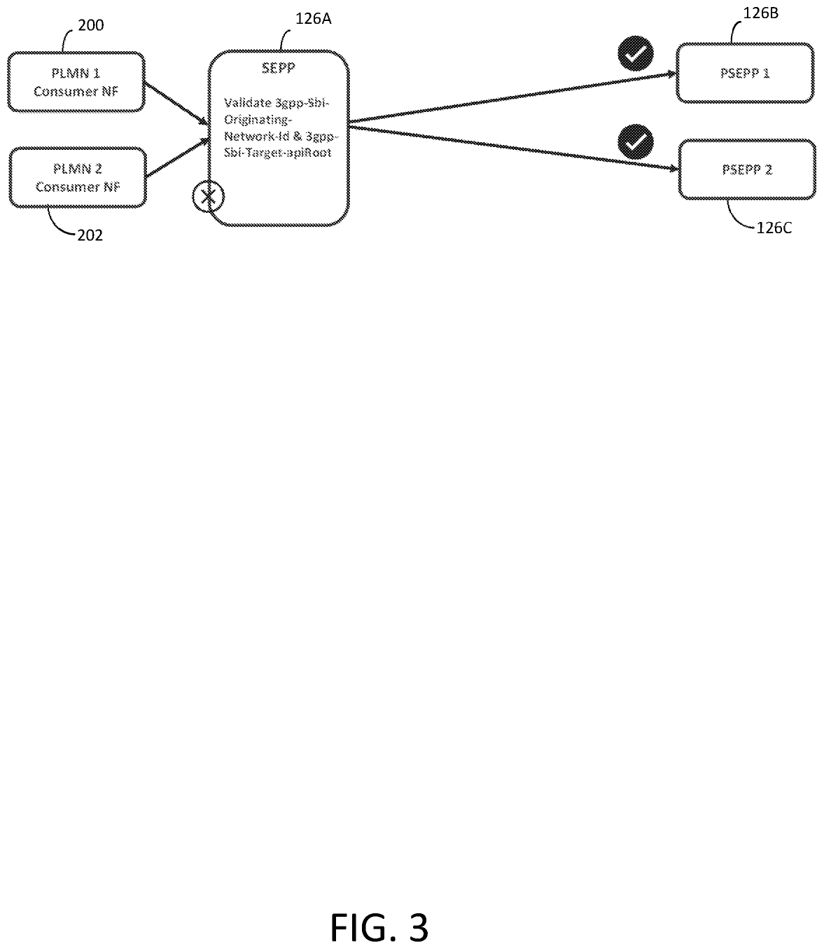

To address this issue, SEPP 126A performs originating and target network validation to enforce roaming agreements. FIG. 3 is a network diagram illustrating a SEPP that forwards messages between PLMNs and performs originating and target network validation to enforce roaming agreements. In FIG. 3, as in FIG. 2, it is assumed that consumer NF 200 resides in PLMN 1, consumer NF 202 resides in PLMN 2, P-SEPP 126B protects PLMN 3, and P-SEPP 126C protects PLMN 4. C-SEPP 126A has N32 connections with P-SEPPs 126B and 126C. The network operator of PLMN 1 has entered into a roaming agreement with the network operator of PLMN 3 but not PLMN 4. To implement this agreement, C-SEPP 126A performs originating and target network screening for inter-PLMN messages. Specifically, C-SEPP 126A performs the following actions for egress messages:
retrieve the serving network ID from the 3gpp-Sbi-Originating-Network-Id header;
retrieve the target network ID from the 3gpp-sbi-target-apiRoot header.
check/assert that the serving network ID is in an allowed list of serving network IDs (or in a blocked list of serving network IDs) for the target PLMN (mapping pre-configured by the user); and.
if the serving network ID is present in the allowed list of serving network IDs for the target PLMN previously retrieved from the 3gpp-sbi-target-apiRoot header, then the message is forwarded towards the target NF, otherwise the message is rejected as per network operator configuration.
   C-SEPP 126A may also perform screening at the SEPP level such that messages to a particular target SEPP are allowed or blocked depending on agreements between originating network operators and network operators associated with the target SEPP (which may include more than one network operator for the case where the target SEPP protects multiple PLMNs).

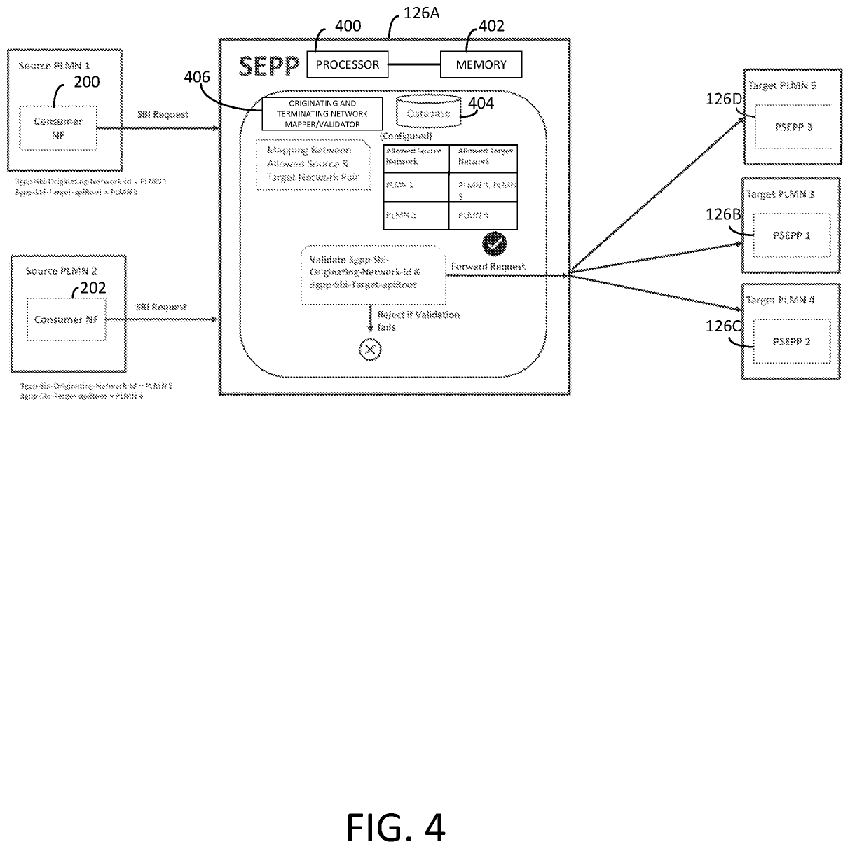

FIG. 4 is a block diagram illustrating an exemplary architecture of a SEPP that forwards messages between PLMNs and performs originating and target network validation to enforce roaming agreements. FIG. 4, SEPP 126A includes at least one processor 400 and memory 402. SEPP 126A further includes an originating and target network mapper/validator 404 that receives egress SBI request messages and performs originating and target network validation using originating and target network mapping data stored in originating and target network mapping database 406. In the illustrated example, originating and target network mapping database 406 includes records, where each record includes a source network identifier as a lookup key and one or more allowed target network identifiers that are mapped to the source network identifier. In FIG. 4, originating and target network mapping database 406 maps PLMN 1 to PLMN 3 and PLMN 5. Originating and target network mapping database 406 also includes a mapping between PLMN 2 PLMN 4. Accordingly, when consumer NF 200 located in PLMN 1 sends a message to PLMN 3, originating and target network mapper/validator 404 extracts the originating network ID from the 3GPP-Sbi-Originating-Network-Id header. Originating and target network mapper/validator 404 performs a lookup in originating and target network mapping database 406 and locates the record corresponding to PLMN 1. Originating and target network mapper/validator 404 extracts the target network identifier from the 3gpp-Sbi-Target-apiRoot header. In this example, PLMN 3 is in the allowed list of PLMN 1. Accordingly, originating and target network mapper/validator 404 allows the message to pass to PLMN 3.

In another example, consumer NF 202 located in PLMN 2 originates a message addressed to PLMN 4. Originating and target network mapper/validator 404 performs a lookup in originating and target network mapping database 406 using the PLMN 1 obtained from the 3gpp-Sbi-Originating-Network-Id header of the message. In this example, PLMN 2 is allowed to forward messages to PLMN 4. Accordingly, originating and target network mapper/validator 404 allows the message to pass to target PLMN 4. If consumer NF 202 originates a message to PLMN 3 or PLMN 5, originating and target network mapper/validator 404 will perform a lookup in originating and target network mapping database 406 and determine that PLMNs 3 and 5 are not mapped to PLMN 2. Accordingly, originating and target network mapper/validator 404 will reject the message.

User will configure the allowed Ingress PLMNs (Serving Network IDs) for every target PLMN or PSEPP. Table 1 shown below illustrates an example of mappings that a user may configure in database 406.

TABLE 1
Originating and Target Network Mappings

| | | | | Network |
|---|---|---|---|---|
| | Association | Serving | Target | Security |
| Record No. | Type | Network ID | PLMN | Action |
| 1 | SEPP | PLMN 1 | P-SEPP 1 | REJECT |
| | | | PLMNs | |
| 2 | PLMN | PLMN 2 | PLMN 4 | FORWARD |

In Table 1, record #1 maps serving network ID PLMN 1 to a target SEPP ID, P-SEPP 1. The network security action configured for record #1 is REJECT. Accordingly, a C-SEPP configured with record #1 will reject all messages originating from PLMN 1 that are directed to P-SEPP 1. Record #2 in Table 1 maps PLMN 2 to PLMN 4. The network security action for record #2 is FORWARD. Accordingly, when a SEPP receives an SBI request message from PLMN 2 and destined to PLMN 4, the SCP will forward the message.

In summary, when a 5G SBI request message arrives at a SEPP, the SEPP will retrieve the serving network ID from 3gpp-Sbi-Originating-Network-Id header. The SEPP will retrieve the target network ID from the 3gpp-Sbi-Target-apiRoot header. If the SEPP finds the serving network ID in allowed list of serving network IDs for the target PLMN (as shown in Table 1), then the SEPP forwards the message towards the target NF. If the association type is in the database record set to SEPP (as shown in record #1 in Table 1), then any of the PLMNs associated with the P-SEPP will be considered as allowed or blocked, depending on the network security action configured for the rule by the network operator.

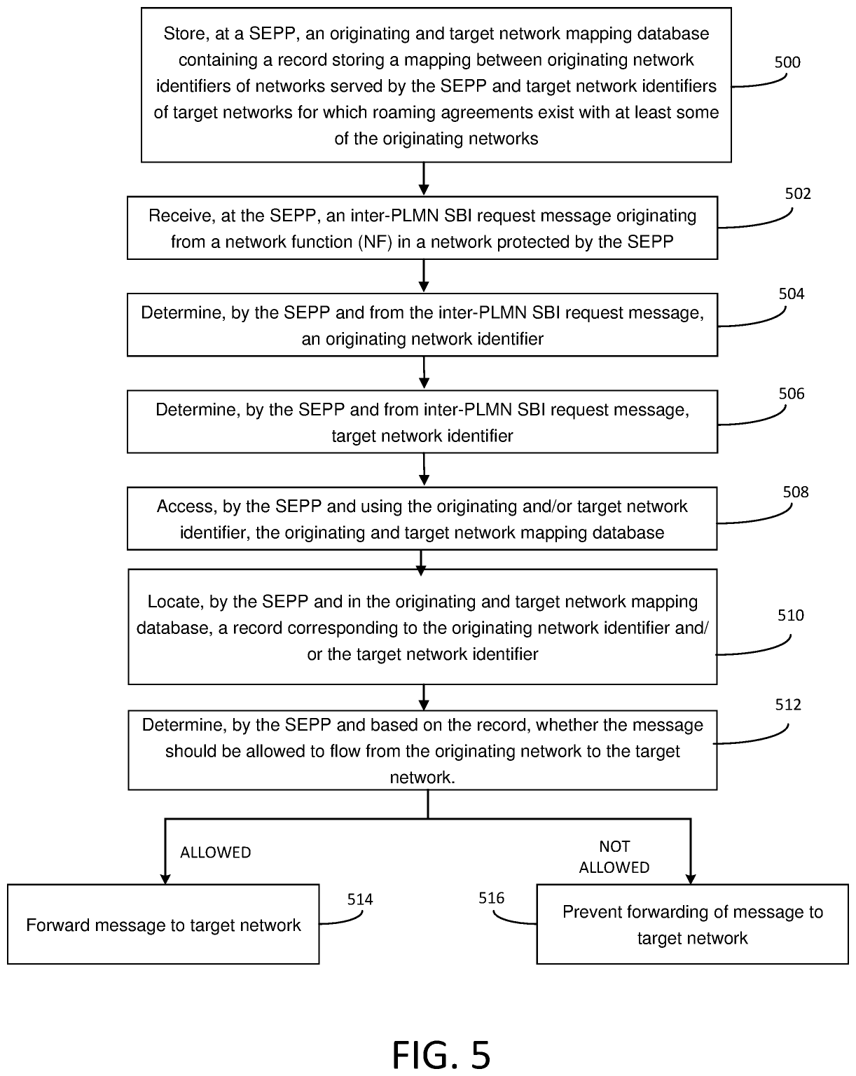

FIG. 5 is a flow chart illustrating an exemplary process performed by a SEPP for forwarding messages between PLMNs and performing originating and target network validation to enforce roaming agreements. Referring to FIG. 5, in step 500, the process includes storing, at a SEPP, an originating and target network mapping database containing a record storing a mapping between originating network identifiers of networks served by the SEPP and target network identifiers of target networks for which roaming agreements exist with at least some of the originating networks. For example, SEPP 126A may include originating and target network mapping database 406, which includes records that map originating network IDs to target network IDs identifying target networks to which the originating network corresponding to the originating network ID is allowed to send messages. In an alternate example, originating and target network mapping database 406 may include at least some records that map an originating network ID to target network IDs corresponding to target networks that block messages from networks corresponding to the originating network IDs. The records may correspond to roaming agreements between operators of the originating and target networks.

In step 502, the process further includes receiving, at the SEPP, an inter-PLMN SBI request message originating from a network function (NF) in a network protected by the SEPP. For example, SEPP 126A may receive an inter-PLMN SBI request message from one of a plurality of PLMNs protected by SEPP 126A.

In step 504, the process further includes determining, by the SEPP and from the inter-PLMN SBI request message, an originating network identifier. In one example, SEPP 126A reads the originating network identifier from the 3gpp-Sbi-Originating-Network-Id header of the message. As will be described in more detail below, if the inter-PLMN SBI request message does not include a 3gpp-Sbi-Originating-Network-Id header, SEPP 126A may determine the originating network ID for the message using another attribute in the message, as will be described in more detail below. The subject matter described herein is not limited to determining the originating network identifier from the 3gpp-Sbi-Originating-Network-Id header. SEPP 126A may determine the originating network identifier from any header in the SBI request message that conveys or can be used to determine or look up the originating network identifier.

In step 506, the process further includes determining, by the SEPP and from the inter-PLMN SBI request message, a target network identifier. In one example, SEPP 126A may read the target network identifier from the 3gpp-Sbi-Target-apiRoot header of the SBI request message. The subject matter described herein is not limited to determining the target network identifier from the 3gpp-Sbi-Target-apiRoot header. SEPP 126A may determine the target network identifier from any header in the SBI request message that conveys or can be used to determine or look up the target network identifier.

In step 508, the process further includes accessing, by the SEPP and using the originating and/or target network identifier, the originating and target network mapping database. For example, SEPP 126A may perform a lookup in originating and target network mapping database 406 using the originating network identifier determined in step 504 and/or the target network identifier determined in step 506.

In step 510, the process further includes locating, by the SEPP and in the originating and target network mapping database, a record corresponding to the originating network identifier and/or the target network identifier. For example, SEPP 126A may locate a record in database 406 that with a network identifier that matches the originating network identifier, the target network identifier, or both.

In step 512, the process further includes determining, by the SEPP and based on the record, whether the message should be allowed to flow from the originating network to the target network. For example, SEPP 126A may determine whether the record indicates that the target network is an allowed network for the originating network, the originating network is an allowed originating network for the target network, the originating network is a blocked network for the target network, the target network is a blocked network for the originating network, etc.

In step 512, the process further includes, when record indicates that the message should be allowed to flow from the originating network to the target network, forwarding the message to the target network. For example, SEPP 126A may forward messages passing the security screening to their respective target networks.

In step 514, the process further includes, when record fails to indicate that that the message should be allowed to flow from the originating network to the target network, preventing forwarding of the message to the target network. For example, SEPP 126A may block or refrain from forwarding messages for which the originating and target network screening fails.

As stated above, in some cases, SBI request messages may not include a 3gpp-Sbi-Originating-Network-Id header. In such cases, SEPP 126A may perform one of the methods described in commonly-assigned, co-pending U.S. patent application Ser. No. 18/414,455, filed on Jan. 16, 2024, the disclosure of which is incorporated herein by reference in its entirety, to determine an originating network ID for the message, add a 3gpp-Sbi-Originating-Network-Id header to the message, and populate the header with the originating network ID. The originating network ID determined in such a manner may be used for originating and target network screening as described herein. In summary, the methods for determining the originating network ID when a message does not include a 3gpp-Sbi-Originating-Network-Id header include using the domain name system (DNS) or a database record including a mapping between a dynamically assigned message identifier and the originating network identifier to determine the originating network identifier for a received message. To use DNS, when SEPP 126A receives an SBI request message, SEPP 126A may query DNS using a 3GPP-defined inter-PLMN fully qualified domain name (FQDN) format, such as nrf.5gc.mnc<MNC1>.mcc<MCC1>.3gppnetwork.org, where MNC1 and MCC1 are PLMN IDs of a local list of PLMN IDs. The PLMN ID for which a successful DNS response is received is used as the source PLMN ID for originating and target network screening as described herein.

To use a dynamically-assigned message identifier to determine the source PLMN ID, SEPP 126A receives a message without an originating network ID, extracts a dynamically assigned message identifier from the message, and uses the dynamically assigned message identifier to access a database record that maps the dynamically assigned message identifier to an originating network ID, where the mapping was determined from, in one example, smContextCreateData from a previous message. Further detail can be found in the above-referenced commonly-assigned, co-pending patent application.

Exemplary advantages of the subject matter described herein include addressing security attacks initiated from networks that are not served by the SEPP. The originating and target network screening can be implemented by configuring database 406 at run time without requiring software modifications. Such a solution provides increased flexibility as security and/or business rules evolve.

The subject matter described herein can be implemented at any suitable SEPP, including a non-hosted SEPP, a hosted-SEPP, a SEPP that functions as a roaming hub, a P-SEPP, and a C-SEPP. A hosted SEPP is a SEPP hosted by an IP exchange (IPX) provider. A non-hosted SEPP is a SEPP operated by the same network operator that operates the PLMN. A roaming hub is an interconnection platform used to connect different mobile networks and is operated by a roaming hub provider.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 18) 3GPP TS 29.510 V18.5.0 (2023-12)
2. 3^{rd} Generation Partnership Project; Technical Specification Group Services and System Aspects; Security architecture and procedures for the 5G System; Stage 2 (Release 18) 3GPP TS 33.501 V18.4.0 (2023-12)
3. 3^{rd} Generation Partnership Project; Technical Specification Group Core Network and Terminals; 5G System; Technical Realization of Service Based Architecture; Stage 3 (Release 18) 3GPP TS 29.500 V18.4.0 (2023-12)
4. 3^{rd} Generation Partnership Project; Technical Specification Group Core Network and Terminals; 5G System; Public Land Mobile Network (PLMN) Interconnection; Stage 3 (Release 18) 3GPP TS 29.573 V18.5.0 (2023-12)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for screening inter-public land mobile network (PLMN) messages at a security edge protection proxy (SEPP) to implement roaming agreements, the method comprising:
storing, in memory accessible by the SEPP, an originating and target network mapping database containing records including mappings between originating network identifiers and target network identifiers;
receiving, by the SEPP, an inter-PLMN SBI request message originating from a network function (NF) in a network served by the SEPP;
determining, by the SEPP and from the inter-PLMN SBI request message, an originating network identifier;
determining, by the SEPP and from the inter-PLMN SBI request message, a target network identifier;
accessing, by the SEPP and using the originating and target network identifiers determined from the message, the originating and target network mapping database;
locating, by the SEPP and in the originating and target network mapping database, a record corresponding to the originating network identifier and/or the target network identifier;
determining, by the SEPP and from the record, whether the message should be allowed to flow from an originating network corresponding to the originating network identifier to a target network corresponding to the target network identifier;
when the SEPP determines that the message should be allowed to flow from the originating network to the target network, forwarding the message to the target network; and
when the SEPP determines that the message should not be allowed to flow from the originating network to the target network, preventing forwarding of the message to the target network.

2. The method of claim 1 wherein the records include mappings between allowed or blocked originating network identifiers for target networks indicated by the target network identifiers.

3. The method of claim 1 wherein the records include mappings between allowed or blocked target network identifiers for originating networks indicated by the originating network identifiers.

4. The method of claim 1 wherein originating and target network identifiers in the records include PLMN identifiers or SEPP identifiers.

5. The method of claim 1 wherein determining the originating network identifier from the message includes reading the originating network identifier from a 3gpp-Sbi-Originating-Network-Id header of the message.

6. The method of claim 5 wherein determining the target network identifier from the message includes determining the target network identifier from a 3gpp-Sbi-Target-apiRoot header of the message.

7. The method of claim 1 wherein determining the originating network identifier from the message includes performing a domain name system (DNS) lookup using a fully qualified domain name (FQDN) constructed from the message and treating the FQDN as the originating network identifier when the DNS lookup returns a success response.

8. The method of claim 1 wherein determining the originating network identifier from the message includes reading a dynamically assigned message identifier from the message and using the dynamically assigned message identifier to determine the originating network identifier.

9. The method of claim 1 wherein determining whether the message should be allowed to flow from the originating network to the target network includes determining whether the originating network identifier determined from the message matches an originating network identifier in the record and determining whether the target network identifier determined from the message matches a target network identifier in the record.

10. The method of claim 1 wherein the SEPP operates as one of: a hosted SEPP, a non-hosted SEPP, a roaming hub, a producer SEPP (P-SEPP) and a consumer SEPP (C-SEPP).

11. A system for screening inter-public land mobile network (PLMN) messages at a security edge protection proxy (SEPP) to implement roaming agreements, the system comprising:
a SEPP including at least one processor and a memory;
an originating and target network mapping database stored in the memory and containing a record storing mappings between originating network identifiers and target network identifiers; and
an originating and target network mapper/validator implemented by the at least one processor for receiving an inter-PLMN SBI request message originating from a network function (NF) in a network served by the SEPP, determining, from the inter-PLMN SBI request message, an originating network identifier, determining, from the inter-PLMN SBI request message, a target network identifier, accessing, using the originating and target network identifiers determined from the message, the originating and target network mapping database, locating, in the originating and target network mapping database, a record corresponding to the originating network identifier and/or the target network identifier, determining, from the record, whether the message should be allowed to flow from an originating network corresponding to the originating network identifier to a target network corresponding to the target network identifier, when the originating and target network mapper/validator determines that the message should be allowed to flow from the originating network to the target network, forwarding the message to the target network, and when the originating and target network mapper/validator determines that the message should not be allowed to flow from the originating network to the target network, preventing forwarding of the message to the target network.

12. The system of claim 11 wherein the records include mappings between allowed or blocked originating network identifiers for target networks indicated by the target network identifiers.

13. The system of claim 11 wherein the records include mappings between allowed or blocked target network identifiers for originating networks indicated by the originating network identifiers.

14. The system of claim 11 wherein originating and target network identifiers in the records include PLMN identifiers or SEPP identifiers.

15. The system of claim 11 wherein the originating and target network identifier validator/mapper is configured to read the originating network identifier from a 3gpp-Sbi-Originating-Network-Id header of the message.

16. The system of claim 15 wherein the originating and target network identifier validator/mapper is configured to read the target network identifier from a 3gpp-Sbi-Target-apiRoot header of the message.

17. The system of claim 11 wherein the originating and target network identifier validator/mapper is configured to determine the originating network identifier from the message by performing a domain name system (DNS) lookup using a fully qualified domain name (FQDN) constructed from the message and treating the FQDN as the originating network identifier when the DNS lookup returns a success response.

18. The system of claim 11 wherein the originating and target network identifier validator/mapper is configured to determine the originating network identifier from the message by reading a dynamically assigned message identifier from the message and using the dynamically assigned message identifier to determine the originating network identifier.

19. The system of claim 11 wherein the originating and target network identifier validator/mapper is configured to determine whether the message should be allowed to flow from the originating network to the target network by determining whether the originating network identifier determined from the message matches an originating network identifier in the record and determining whether the target network identifier determined from the message matches a target network identifier in the record.

20. A non-transitory computer readable medium having stored thereon executable instructions that when executed by a processor of a computer control the computer to perform steps comprising:
storing, in memory accessible by security edge protection proxy (SEPP), an originating and target network mapping database containing records including mappings between originating network identifiers and target network identifiers;
receiving, by the SEPP, an inter-PLMN SBI request message originating from a network function (NF) in a network served by the SEPP;
determining, by the SEPP and from the inter-PLMN SBI request message, an originating network identifier;
determining, by the SEPP and from the inter-PLMN SBI request message, a target network identifier;
accessing, by the SEPP and using the originating and target network identifiers determined from the message, the originating and target network mapping database;
locating, by the SEPP and in the originating and target network mapping database, a record corresponding to the originating network identifier and/or the target network identifier;
determining, by the SEPP and from the record, whether the message should be allowed to flow from an originating network corresponding to the originating network identifier to a target network corresponding to the target network identifier;
when the SEPP determines that the message should be allowed to flow from the originating network to the target network, forwarding the message to the target network; and
when the SEPP determines that the message should not be allowed to flow from the originating network to the target network, preventing forwarding of the message to the target network.
